(19) United States
(12) Patent Application Publication
(10) Pub. No.: US 2011/0240929 A1
(43) Pub. Date: Oct. 6, 2011

(54) POLYMER/CARBON NANOTUBE COMPOSITE FILM WITH HIGH GAS PERMEABILITY RESISTANCE AND MANUFACTURING METHOD THEREOF

(76) Inventors: CHENG-CHIEN YANG, Longtan Township (TW); Jui-Ming Yeh, Zhongli City (TW); Chin-Yih Chen, Longtan Township (TW); Kuan-Yeh Huang, Zhongli City (TW)

(21) Appl. No.: 12/753,621

(22) Filed: Apr. 2, 2010

(51) Int. Cl. H01B 1/24; B82Y 30/00

(52) U.S. Cl. 252/511; 977/742; 977/752

(57) ABSTRACT

The invention provides a polymer/carbon nanotube composite film with high gas permeability resistance and manufacturing method thereof. The manufacturing method uses the in-situ polymerization method to form a polyaniline polymer composite material with multi-layer carbon nanotubes. Then, the polyaniline polymer composite material is under a heat reflux modification to form a charge transferring compound, so that the multi-layer carbon nanotubes will be distributed in a polyaniline polymer substrate uniformly and dispersively, and the gas permeability resistance of the polymer/carbon nanotube composite film can be largely improved.

### BACKGROUND OF THE INVENTION

1. Field of the Invention

The present invention relates to a nano composite material, and more particularly, to a polymer/carbon nanotube composite film with high gas permeability resistance and a manufacturing method thereof.

2. Description of the Prior Art

In general, the gas barrier coating material can be divided into three types of an organic material, an inorganic material, and an organic/inorganic mixed material. The inorganic coating material is deposited by a drying deposition method, such as sputter, plasma deposition, or chemical vapor deposition (CVD), so that a layer of transparent metal inorganic film (a thickness of 2˜1000 nm) is deposited on the surface of the substrate to keep the moisture and oxygen away. And, the wetting deposition method such as spin coating, dip coating, doctor blade coating, roll coating can be used to form a film of a thickness of 1˜20 mm. The wetting deposition method is not only suitable for high-speed and large-scale production, and more suitable for continuous production of the polymer organic plastic material. As to the organic/inorganic mixed material, the inorganic material is added to make the gas penetrating path to be more rugged to enhance the gas-barrier property of the organic plastic material and the characteristics of the polymer material will be also largely enhanced.

Currently, the most common application of the gas-barrier film is the coating material technology, such as the surface of the flat display (e.g., LCD and LED) substrate. Since the electronic product is developed toward the trend of reducing weight and shrinking size, even though the glass substrate is used in current flat displays, it will be replace by the plastic substrate in near future. Because the plastic substrate has lighter weight and thin thickness to solve disadvantages of easy broken and intolerant shock of the glass substrate, and also has advantages of flexible and can be processed in different shapes to provide design freedom for the appearance of the new generation flat display and the convenience of easy to carry for the user.

It should be noticed that the gas-barrier property of the plastic substrate is poor than the glass substrate, therefore, it is necessary to coat a gas barrier layer on the surface of the plastic substrate to achieve the requirement of high oxygen barrier ratio and low moisture penetration rate (for LCD substrate, the gas barrier rate should be lower than 0.10 cc/m² day and the moisture penetration rate should be lower than 0.15 g/m² day; for the LED substrate, the gas barrier rate should be lower than 10-5 cc/m² day and the moisture penetration rate should be lower than 10-6 g/m² day). In general, the polyethylene terephthalate or nylon are selected to be the polymer gas barrier material, and a natural inorganic layered material (e.g., natural clay) is added to block the gas penetrated in the polymer. However, the current gas barrier effect is not ideal enough, so that there is still considerable room for improvement.

Therefore, a scope of the invention is to provide a polymer/carbon nanotube composite film with high gas permeability resistance and a manufacturing method thereof, so that the problems occurred in prior arts can be solved.

### SUMMARY OF THE INVENTION

Since the nanotube has higher specific surface area than the ordinary natural clay, and the polyaniline has excellent compatibility with the nanotube, therefore, the invention uses the aniline monomers to modify the nanotube, so that the nanotube can be uniformly distributed in the polyaniline to block the gas diffusion path to enhance the gas barrier ability of the polymer/carbon nanotube composite film. In addition, different protonic acids are added to the polymer/carbon nanotube composite film in this invention, so that the gas barrier ability of the polymer/carbon nanotube composite film will be enhanced due to the protonic acids doping effect.

According to an embodiment of the invention, the polymer/carbon nanotube composite film with high gas permeability resistance includes multi-layer carbon nanotubes and a polyaniline polymer substrate. The multi-layer carbon nanotubes are uniformly and dispersively distributed in a polyaniline polymer substrate, so that the gas diffusion path in the polyaniline polymer substrate will be blocked and the gas permeability resistance of the polymer/carbon nanotube composite film can be effectively improved.

In practical applications, an in-situ polymerization method is used to synthesize a plurality of aniline monomers and the plurality of multi-layer carbon nanotubes, and then a heat refluxing modification method is used to form a charge-transfer complex, so that the structure of the polymer/carbon nanotube composite film with high gas permeability resistance can be formed.

Another embodiment of the invention is a polymer/carbon nanotube composite film with high gas permeability resistance manufacturing method including the steps of: (a) using an in-situ polymerization method to synthesize a plurality of aniline monomers and a plurality of multi-layer carbon nanotubes to be a polymer/carbon nanotube composite material; (b) using a heat refluxing modification method to modify the polymer/carbon nanotube composite material to form a charge-transfer complex to make the plurality of multi-layer carbon nanotubes to be uniformly distributed in a polyaniline polymer substrate formed by the plurality of aniline monomers. Therefore, the gas diffusion path in the polyaniline polymer substrate will be blocked and the gas permeability resistance of the polymer/carbon nanotube composite film can be effectively improved.

The objective of the present invention will no doubt become obvious to those of ordinary skill in the art after reading the following detailed description of the preferred embodiment, which is illustrated in the various figures and drawings.

### BRIEF DESCRIPTION OF THE APPENDED DRAWINGS

FIG. 1 illustrates a scheme diagram of a polymer/carbon nanotube composite film of an embodiment of the invention.

FIG. 2(A) illustrates a scheme diagram of the multi-layer carbon nanotubes uniformly distributed in a polyaniline polymer substrate to block the gas diffusion path in the polyaniline polymer substrate.

FIG. 2(B) illustrates a scheme diagram of the polymer/carbon nanotube composite film with high gas permeability resistance only including the polyaniline polymer substrate so that the gas diffusion path in the polyaniline polymer substrate is hard to be blocked.

FIG. 3 illustrates a flowchart of the polymer/carbon nanotube composite film with high gas permeability resistance manufacturing method in another embodiment of the invention.

FIG. 4(A) shows the aniline monomer; FIG. 4(B) shows the polymer polyaniline synthesized by the aniline monomers shown in FIG. 4(A).

FIG. 5 shows a flowchart of synthesizing the polymer polyaniline.

FIG. 6 shows a flowchart of synthesizing the aniline and multi-layer carbon nanotubes to be the polymer polyaniline/carbon nanotube composite material.

FIG. 7 shows a flowchart of manufacturing a conductive polymer thin film.

FIG. 8 shows a flowchart of manufacturing polyaniline/nano-clay powder.

### DETAILED DESCRIPTION OF THE INVENTION

The invention provides a polymer/carbon nanotube composite film with high gas permeability resistance and a manufacturing method thereof. At first, the nano composite material will be introduced in short.

“Nano composite material” began at late of 80' in the 20th century, it is defined to be formed from two or more than two kinds of materials, and one-dimension of the “Nano composite material” is the composite material synthesized in the size of nano-level (1˜100 nm). This nano-level dimension can be inorganic, organic, or both. Since the nano composite material is a complex combined by two or more different materials through various means and the synergy effect of all composition materials, therefore, the nano composite material may have excellent comprehensive performance better than single material, such as the advantages of larger hardness, higher strength, and lighter weight. And, it can be designed and manufactured based on practical needs to satisfy all special using requirements.

In all kinds of nano composite materials, due to the nano-level organic/inorganic composite materials have inorganic characteristics (e.g., heat resistant, vibration resistant, and pulling resistant) and organic characteristics (e.g., plastic, transparent, and folding resistant), and the advantages of lighter weight and lower cost than conventional filling compounds, so that the nano-level organic/inorganic composite materials can be widely applied to anti-corrosion, communications, optical materials, electronic components, biomedical materials, environmental protection, aviation, automotive and other industries, it has very strong market potential.

Next, the composite materials formed by carbon nanotubes will be discussed. The carbon nanotube is formed by winding the layer structure of graphite; therefore, it can be regarded as the hollow columnar structure formed by aligning the hexagonal lattices. If the carbon nanotube is distinguished by the number of the layers of the graphite, the carbon nanotube can be divided into a single layer carbon nanotube and multi-layer carbon nanotubes. In various kinds of conductive polymers, because the polyaniline has many excellent characteristics, the synthesis preparation of the raw materials is easier, stable for the environment, and can combine with the protonated doping effect, the polyaniline has become one of the most practical conductive polymer materials.

However, all of the researches related to nanotube and conductive polymer composite material stress on the applications of electronic conduction and heat property instead of the gas barrier characteristic. Therefore, in order to effectively enhance the gas barrier ability of the composite material, the invention provides a polymer/carbon nanotube composite film with high gas permeability resistance and a manufacturing method thereof.

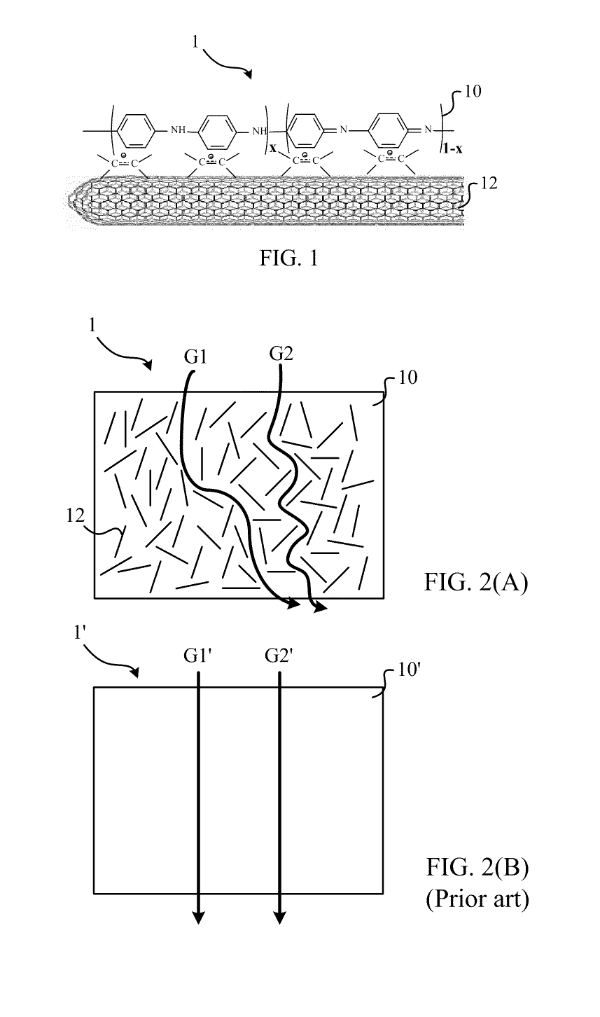

An embodiment of the invention is a polymer/carbon nanotube composite film with high gas permeability resistance. As shown in FIG. 1, the polymer/carbon nanotube composite film with high gas permeability resistance 1 includes a polyaniline polymer substrate 10 and multi-layer carbon nanotubes 12. It should be noticed that as shown in FIG. 2(A), since the multi-layer carbon nanotubes 12 are uniformly distributed in the polyaniline polymer substrate 10, therefore, the diffusion paths of the gases G1 and G2 in the polyaniline polymer substrate 10 will be blocked to effectively enhance the gas permeability resistance of the polymer/carbon nanotube composite film 1.

As to FIG. 2(B), FIG. 2(B) shows in the prior art, when the polymer/carbon nanotube composite film with high gas permeability resistance 1′ only includes the polyaniline polymer substrate 10′, the diffusion paths of the gases G1′ and G2′ will be blocked very few times, therefore, the gas barrier characteristic of the polymer/carbon nanotube composite film with high gas permeability resistance 1′ will become very poor.

In practical applications, when an in-situ polymerization method is used to synthesize a plurality of aniline monomers and the plurality of multi-layer carbon nanotubes to form a composite material, a selective in-situ force is formed between the oxidation units of the polyaniline polymer substrate and the plurality of multi-layer carbon nanotubes, the selective in-situ force can help the charge transferring conditions of two composites and affect the conduction properties of the composites. Therefore, after the multi-layer carbon nanotubes are added into the polyaniline polymer substrate, its conduction properties will be largely improved.

Then, a heat refluxing modification method is used to the polyaniline/carbon nanotubes composite material to form a charge-transfer complex. Its experiment method is to put the carbon nanotubes in the aniline monomer solution, and refluxed by heating and mixed 3 hours under a dark environment. When the experiment begins, the solution will be transferred from the original transparent state to be brown, and at last the dark red state. It means that the carbon nanotubes are dissolved in the aniline solution and the structure of the polymer/carbon nanotube composite film with high gas permeability resistance mentioned above is formed, but not limited to this case. From the results of the experiments, it can be found that in the polymer/carbon nanotube composite film with high gas permeability resistance processed by heat refluxing, the blockage of the uniformly distributed carbon nanotubes will increase the number of the gas (e.g., oxygen, nitrogen, and methane) penetrating paths to cause the lowering of the penetration rate, and the added multi-layer carbon nanotubes will block the movement of the polymer chain, so that the gas will be hard to pass through the polymer thin film during the diffusion process.

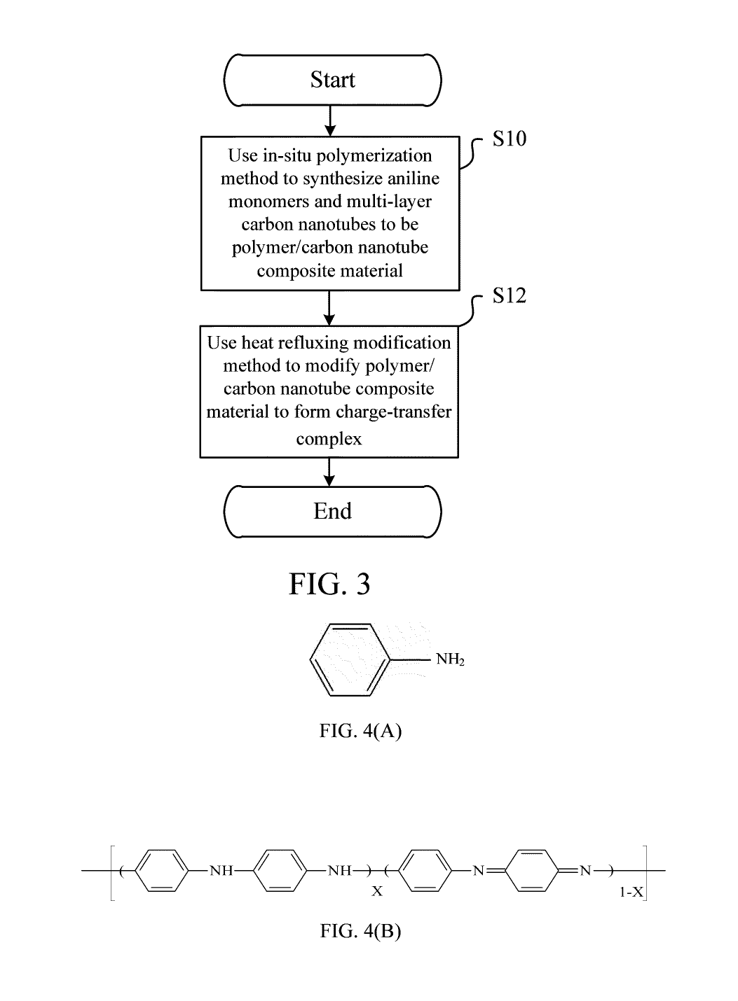

Another embodiment of the invention is a polymer/carbon nanotube composite film with high gas permeability resistance manufacturing method. Please refer to FIG. 3. FIG. 3 shows the flowchart of the manufacturing method. As shown in FIG. 3, at first, the method performs the step S10 to use an in-situ polymerization method to synthesize a plurality of aniline monomers and a plurality of multi-layer carbon nanotubes to be a polymer/carbon nanotube composite material. Then, the method performs the step S12 to use a heat refluxing modification method to modify the polymer/carbon nanotube composite material to form a charge-transfer complex to make the plurality of multi-layer carbon nanotubes to be uniformly distributed in a polyaniline polymer substrate formed by the plurality of aniline monomers. Therefore, the gas diffusion path in the polyaniline polymer substrate will be blocked and the gas permeability resistance of the polymer/carbon nanotube composite film can be effectively improved.

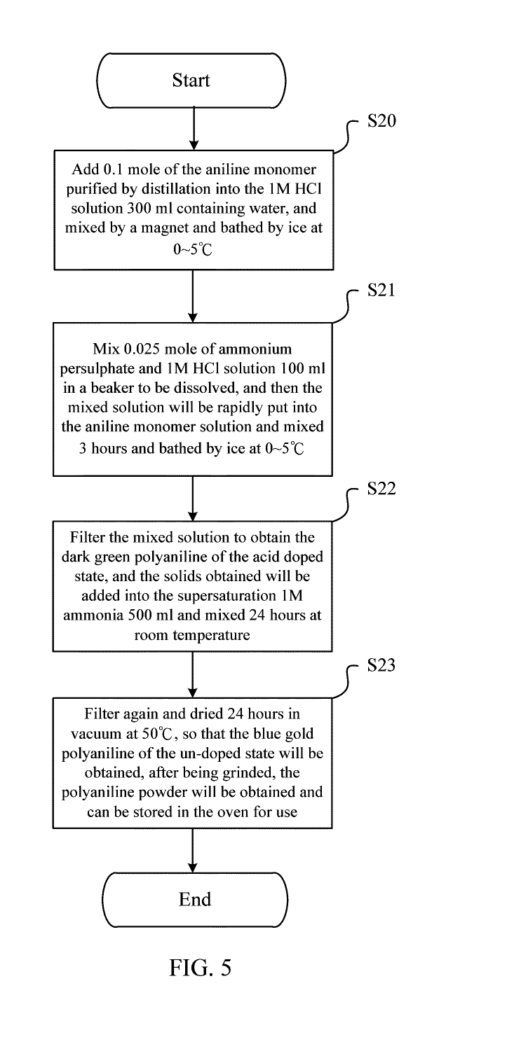

Afterward, the detailed steps of the manufacturing method will be further explained. FIG. 5 shows the steps of synthesizing the aniline monomers shown in FIG. 4(A) to be the polymer polyaniline of FIG. 4(B). As shown in FIG. 5, at first, the method performs the step S20, 0.1 mole of the aniline monomer purified by distillation is added into the 1M HCl solution 300 ml containing water, and mixed by a magnet and bathed by ice at 0˜5° C. Then, the step S21 is performed to mix 0.025 mole of ammonium persulphate and 1M HCl solution 100 ml in a beaker to be dissolved, and then the mixed solution will be rapidly put into the aniline monomer solution and mixed 3 hours and bathed by ice at 0˜5° C. Then, the step S22 is performed to filter the mixed solution to obtain the dark green polyaniline of the acid doped state, and the solids obtained will be added into the supersaturation 1M ammonia 500 ml and mixed 24 hours at room temperature. Afterward, the step S23 will be performed to filter again and dried 24 hours in vacuum at 50° C., so that the blue gold polyaniline of the un-doped state will be obtained. After being grinded, the polyaniline powder will be obtained and can be stored in the oven for use.

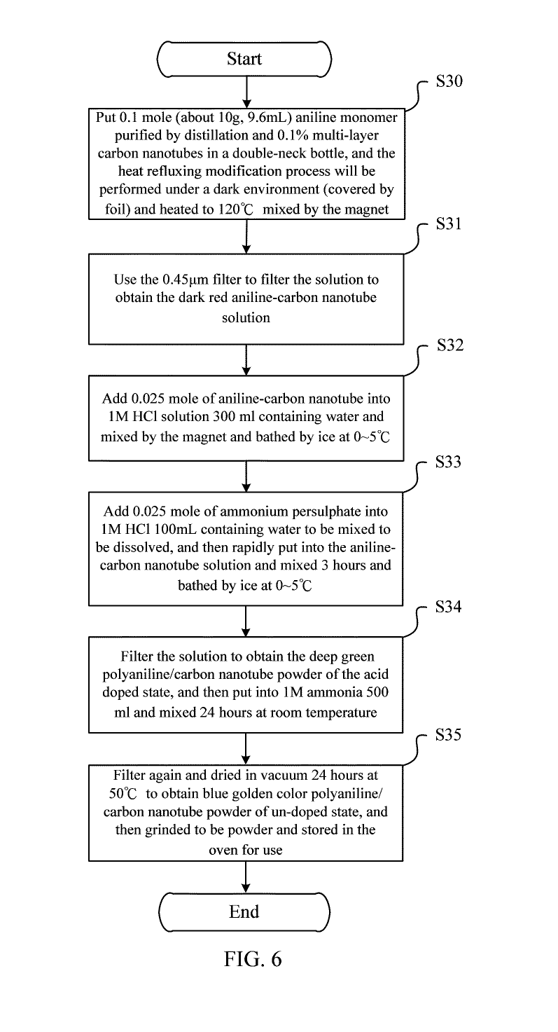

FIG. 6 shows a flowchart of synthesizing the aniline and multi-layer carbon nanotubes to be the polymer polyaniline/carbon nanotube composite material. As shown in FIG. 6, at first, the method performs the step S30 to put 0.1 mole (about 10 g, 9.6 mL) aniline monomer purified by distillation and 0.1% multi-layer carbon nanotubes in a double-neck bottle, and the heat refluxing modification process will be performed under a dark environment (covered by foil) and heated to 120° C. mixed by the magnet. When the experiment begins, the solution will be transformed from the original transparent state to the brown color, after the experiment, the solution will become dark red color state. Next, the step S31 will be performed to use the 0.45 μm filter to filter the solution to obtain the dark red aniline-carbon nanotube solution. Then, the step S32 is performed to add 0.025 mole of aniline-carbon nanotube into 1M HCl solution 300 ml containing water and mixed by the magnet and bathed by ice at 0˜5° C. Afterward, the step S33 is performed to add 0.025 mole of ammonium persulphate into 1M HCl 100 mL containing water to be mixed to be dissolved, and then rapidly put into the aniline-carbon nanotube solution and mixed 3 hours and bathed by ice at 0˜5° C. Afterward, the step S34 is performed to filter the solution to obtain the deep green polyaniline/carbon nanotube powder of the acid doped state, and then put into 1M ammonia 500 ml and mixed 24 hours at room temperature. Then, the step S35 is performed to filter again and dried in vacuum 24 hours at 50° C. to obtain blue golden color polyaniline/carbon nanotube powder of un-doped state, and then grinded to be powder and stored in the oven for use.

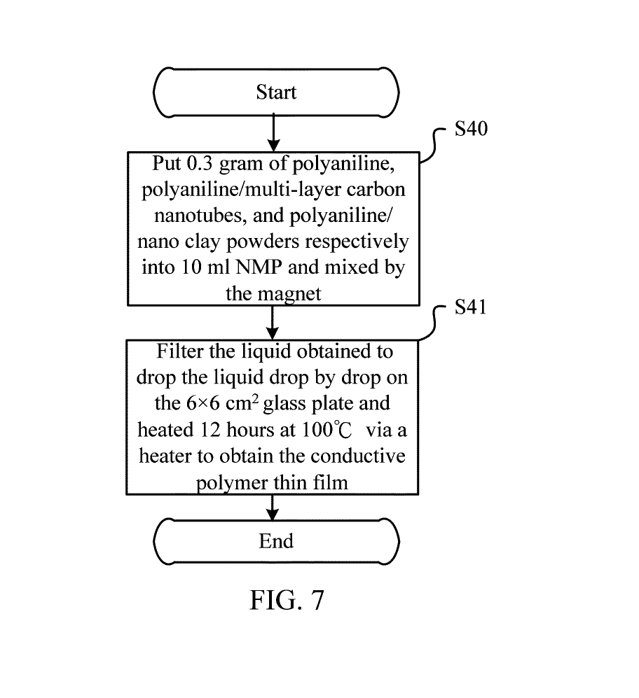

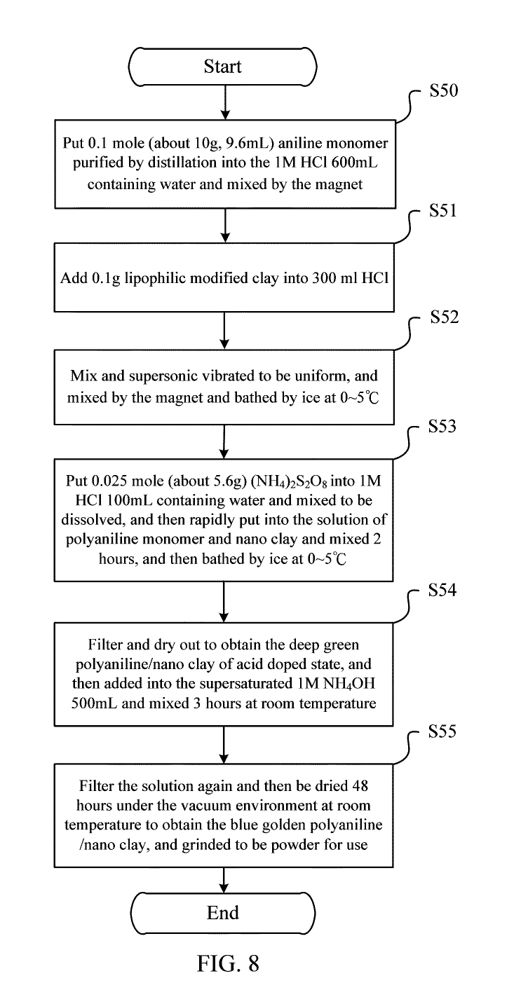

FIG. 7 shows the detailed steps of manufacturing the conductive polymer thin film. As shown in FIG. 7, at first, the manufacturing method performs the step S40 to put 0.3 gram of polyaniline, polyaniline/multi-layer carbon nanotubes, and polyaniline/nano clay powders respectively into 10 ml NMP and mixed by the magnet. At this time, the concentration of the solution is 3 wt-% and it is a dark blue liquid. Next, the step S41 is performed to filter the liquid obtained to drop the liquid drop by drop on the 6×6 cm² glass plate and heated 12 hours at 100° C. via a heater to obtain the conductive polymer thin film.

Wherein, the detailed steps of manufacturing polyaniline/nano clay powders are shown in FIG. 8. As shown in FIG. 8, at first, the method performs the step S50 to put 0.1 mole (about 10 g, 9.6 mL) aniline monomer purified by distillation into the 1M HCl 600 mL containing water and mixed by the magnet. Then, the step S51 is performed to add 0.1 g lipophilic modified clay into 300 ml HCl. Afterward, the step S52 is performed to mix and supersonic vibrated to be uniform, and mixed by the magnet and bathed by ice at 0˜5° C. Then, the step S53 is performed to put 0.025 mole (about 5.6 g) (NH₄)₂S₂O₈ into 1M HCl 100 mL containing water and mixed to be dissolved, and then rapidly put into the solution of polyaniline monomer and nano clay and mixed 2 hours, and then bathed by ice at 0˜5° C. Afterward, the step S54 is performed to filter and dry out to obtain the deep green polyaniline/nano clay of acid doped state, and then added into the supersaturated 1M NH₄OH 500 mL and mixed 3 hours at room temperature. At last, the step S55 is performed to filter the solution again and then be dried 48 hours under the vacuum environment at room temperature to obtain the blue golden polyaniline/nano clay, and grinded to be powder for use.

In addition, the manufacturing method can also further use the doping effect of different protonic acid (e.g., HF, HCl, HBr) to enhance the gas barrier ability of the nano composite material. At first, the method immerses a series of prepared thin films into different 1M protonic acid solutions 3 hours, and then the thin films are dried out in vacuum to measure the permeability of the thin films. It can be found from the practical measuring results that the permeability of the nano composite material will be lowered obviously. The reason to cause this result is that the ions generated by the ionization of the protonic acids will occupy the free volumes in the thin film. With the free volume of the thin film becomes smaller, the thin film will become denser, so that the gas will become harder to penetrate the thin film. Especially, the gas barrier effect generated by the doping of HBr is the best one.

Compared to the prior arts, the invention uses an in-situ polymerization method to synthesize a plurality of aniline monomers and the plurality of multi-layer carbon nanotubes to form a nano composite material, and after the plurality of multi-layer carbon nanotubes and the plurality of aniline monomers are refluxed by heat, the charge-transfer force will be formed between them to form the dispersed nanotube, and this process will be non-covalent bonding behavior. By the identification of the Raman spectroscopy and the Fourier transform infrared spectroscopy, it is confirmed that the adsorption bonding condition between the carbon nanotube and the polyaniline, and the morphological analysis performed by observation of the filed emission scanning electron microscopy and the transmission electron microscopy. It can be found that the carbon nanotube and the polyaniline will form the charge-transfer complex after being refluxed by heat; therefore, it is not easy to observe the covered carbon nanotube on the diagram of the filed emission scanning electron microscopy. Furthermore, it can be observed that the width of the tube will become thicker on the diagram of the transmission electron microscopy, so that it can be proved that the multi-layer carbon nanotubes in this composite material will be existed in the polyaniline polymer substrate in a uniformly distributed form.

As to the gas barrier property, since the multi-layer carbon nanotubes are added and the heat refluxing modification is performed, the multi-layer carbon nanotubes are uniformly distributed in the polyaniline polymer substrate to increase the gas penetrating path and reduce its free volume, so that the oxygen permeability of the nano composite material will be largely lowered, namely, its gas barrier effect is largely enhanced. In addition, it can be found based on the experiment results, the doping of different protonic acid (e.g., HF, HCl, HBr) will largely enhance the gas barrier ability of the nano composite material. Thus, the polymer/carbon nanotube composite film with high gas permeability resistance and the manufacturing method thereof can indeed have a very good gas barrier, thermal stability, electrical conductivity and mechanical properties.

Although the present invention has been illustrated and described with reference to the preferred embodiment thereof, it should be understood that it is in no way limited to the details of such embodiment but is capable of numerous modifications within the scope of the appended claims.

What is claimed is:

1. A polymer/carbon nanotube composite film with high gas permeability resistance comprising:
a polyaniline polymer substrate; and
a plurality of multi-layer carbon nanotubes being uniformly distributed in the polyaniline polymer substrate and used for blocking a diffusion path of a gas in the polyaniline polymer substrate to make the gas hard to penetrate the polyaniline polymer substrate.

2. The polymer/carbon nanotube composite film with high gas permeability resistance of claim 1, wherein an in-situ polymerization method is used to synthesize a plurality of aniline monomers and the plurality of multi-layer carbon nanotubes, and then a heat refluxing modification method is used to form a charge-transfer complex.

3. The polymer/carbon nanotube composite film with high gas permeability resistance of claim 2, wherein after being synthesized by the in-situ polymerization method, a selective in-situ force is formed between the oxidation units of the polyaniline polymer substrate and the plurality of multi-layer carbon nanotubes, so that the polymer/carbon nanotube composite film with high gas permeability resistance has good electronic conduction property.

4. The polymer/carbon nanotube composite film with high gas permeability resistance of claim 2, wherein in the heat refluxing modification method, the plurality of multi-layer carbon nanotubes is disposed in an aniline solution and refluxed by heating and mixed under a dark environment to make the plurality of multi-layer carbon nanotubes to be dissolved in the aniline solution.

5. The polymer/carbon nanotube composite film with high gas permeability resistance of claim 1, further comprising a plurality of protonic acid ions ionized by doping a plurality of protonic acids into the polyaniline polymer substrate, the plurality of protonic acid ions occupying the free volume in the polyaniline polymer substrate to block the gas not penetrating the polyaniline polymer substrate.

6. A polymer/carbon nanotube composite film with high gas permeability resistance manufacturing method, comprising the steps of:
(a) using an in-situ polymerization method to synthesize a plurality of aniline monomers and a plurality of multi-layer carbon nanotubes to be a polymer/carbon nanotube composite material; and
(b) using a heat refluxing modification method to modify the polymer/carbon nanotube composite material to form a charge-transfer complex to make the plurality of multi-layer carbon nanotubes to be uniformly distributed in a polyaniline polymer substrate formed by the plurality of aniline monomers.

7. The manufacturing method of claim 6, wherein in step (a), a selective in-situ force is formed between the oxidation units of the polyaniline polymer substrate and the plurality of multi-layer carbon nanotubes, so that the polymer/carbon nanotube composite film with high gas permeability resistance has good electronic conduction property.

8. The manufacturing method of claim 6, wherein the plurality of multi-layer carbon nanotubes blocks a diffusion path of a gas in the polyaniline polymer substrate to make the gas hard to penetrate the polyaniline polymer substrate.

9. The manufacturing method of claim 8, further comprising the step of:
(c) doping a plurality of protonic acids into the polyaniline polymer substrate to make the plurality of protonic acids to be ionized to form a plurality of protonic acid ions, the plurality of protonic acid ions occupying the free volume in the polyaniline polymer substrate to make the gas harder to penetrate the polyaniline polymer substrate.

10. The manufacturing method of claim 6, wherein in step (b), the plurality of multi-layer carbon nanotubes is disposed in an aniline solution and refluxed by heating and mixed under a dark environment to make the plurality of multi-layer carbon nanotubes to be dissolved in the aniline solution.
